(19) United States
(12) Patent Application Publication
(10) Pub. No.: US 2024/0062074 A1
(43) Pub. Date: Feb. 22, 2024

(54) APPARATUS AND METHOD FOR DISTRIBUTED NEURAL NETWORKS

(71) Applicant: HUAWEI TECHNOLOGIES CO., LTD., Shenzhen (CN)

(72) Inventors: Abdellatif ZAIDI, Boulogne Billancourt (FR); Kevin SCAMAN, Boulogne Billancourt (FR); Pierre ESCAMILLA, Boulogne Billancourt (FR)

(21) Appl. No.: 18/495,528

(22) Filed: Oct. 26, 2023

Related U.S. Application Data
(63) Continuation of application No. PCT/EP2021/060804, filed on Apr. 26, 2021.

(51) Int. Cl. G06N 3/098

(52) U.S. Cl. CPC G06N 3/098

(57) ABSTRACT

The present invention relates to a first device and at least two second devices for performing distributive machine learning and inference in a communication system. Each device comprises a neural network, NN. The NNs are trained distributively in a training phase and may also be activated during the inference phase, so that an amount of data exchange may be reduced in the communication system. During the training phase and the inference phase, the at least two second devices provide activation vectors of output layers of their NNs to the first device. The first device combines those activation vectors to generate an input for its NN. During backpropagation, the first device may split or broadcast an error vector of the input layer of its NN to the at least two second devices. In this way, an arbitrary number of data sources may be handled by the communication system.

### CROSS-REFERENCE TO RELATED APPLICATIONS

This application is a continuation of International Application No. PCT/EP2021/060804, filed on Apr. 26, 2021, the disclosure of which is hereby incorporated by reference in its entirety.

### TECHNICAL FIELD

The present disclosure relates to devices and methods for distributed neural networks in the field of computer technology. In particular, the disclosure relates to devices and methods for distributive neural network learning and inference.

### BACKGROUND

Artificial neural networks, or simply neural networks (NNs), are widely used in machine learning. Typically, there are at least two phases for deploying a NN: a training phase and an inference phase. The training phase is mainly used to allow an untrained NN to learn a new capability from one or more training datasets. Particularly, in the training phase, training datasets comprising labelled or unlabelled training samples are applied to the input of the untrained NN, so that the NN may learn suitable parameters, i.e., may obtain knowledge for performing a specific task through the training phase. In the inference phase, the NN with the learned knowledge, i.e., the trained NN, is applied for the specific task. The term inference may be understood as applying the learned knowledge to infer a result.

A conventional NN is typically trained and applied locally. That is, a local NN is trained and applied on a single device. In some complicated situations, more than one NN may be used by multiple devices in a communication network. For example, source data such as training samples or inputs are obtained from multiple devices or multiple sites. Due to a lack of direct communication, privacy restriction, or throughput restriction, the source data cannot be collected centrally on a single device. In these cases, a set of NN may be used. Conventionally, two schemes are used for training the set of NN: federated learning and split learning.

### SUMMARY

The present disclosure and its embodiments are based on the following further considerations.

In federated learning, only the training phase is performed distributively, but not the inference phase. In particular, a goal of the training phase in federated learning is to obtain a unified NN distributively. During the training phase, every device optimizes its NN and shares optimized parameters with a common agent, known as a parameter server. This parameter server combines received parameters from various devices and then sends back a function of the received parameters (e.g., an average function). Every device then updates its NN by using new parameters received from the parameter server and continues training. The process of local computation on every single device and exchange with the parameter server continues in this way until convergence. At convergence, a unified NN is achieved and shared among all the devices. However, during the inference phase, only one device is engaged. Therefore, input data during the inference phase shall still need to be collected in a central device and feed to the engaged device, which may not be feasible in certain cases.

In split learning or vanilla split learning, the training phase is performed distributively among all devices. The inference phase involves only one device in addition to the parameter server. The split learning aims to learn a NN with two separate parts, i.e., one part of the NN shared by all devices and the other part used by the parameter server. In the training phase, the devices are executed sequentially. In particular, one device computes a forward pass on its part of the data and then sends its output to the parameter server. The parameter server continues the forward pass and then computes the backward propagation until a so-called cut-layer. The output of the cut-layer is then sent to the agent/node who continues the backward pass. This process of forward pass and backward propagation continues until convergence. Parameters of a learned NN are then sent to a next device, which uses those for its NN initialization and then performs the training at its turn. The learned two-part NN is then used during the inference phase, in a distributed manner between two devices: one device having access to input data and another device only contributing to the computation. However, apart from the other part used by the parameter server, all nodes under the parameter server still share a same part of the NN.

As stated above, one disadvantage of the aforementioned two schemes is that only one shared NN is trained for all working nodes. As a consequence, only one source input can be used by a single node during the inference phase.

In view of the above-mentioned problems and disadvantages, embodiments of the present invention aim to facilitate distributed learning and inference of neural networks. An objective thereby is to allow an arbitrary number of input sources used by multiple devices during the training phase and the inference phase.

The objective is achieved by the embodiments of the invention as described in the enclosed independent claims. Advantageous implementations of the embodiments of the invention are further defined in the dependent claims.

A first aspect of the present disclosure provides a first device for a communication network. The communication network comprises at least two second devices. Each of the first device and the at least two second devices comprises a NN. The first device is configured to:
obtain outputs of the NNs comprised in the at least two second devices;
combine the obtained outputs to generate a combined output;
provide the combined output as an input to the NN comprised in the first device; and
run the NN comprised in the first device based on the input.

Notably, the first device may be configured to perform the steps as mentioned above either in the training phase or in the inference phase.

Moreover, the combined output may be referred to as a combination of the obtained outputs of the NNs comprised in the at least two second devices. The first device may use this combined output as the input to its NN.

Optionally, the running of the NN comprised in the first device may be referred to as an execution of the NN comprised in the first device in order to obtain an output corresponding to the input. The execution of the NN is also known as a forward pass of the NN.

After running the NN, the first device may be configured to output a final result based on the output of the output layer, if the first device is the last node. That is, the first device may be a final server that produces a final result. Alternatively, the first device may be configured to provide an output of the NN comprised in the first device to a subsequent device that connects to the output layer of the first device. That is, the first device may be an intermediate device.

Optionally, parameters of the NNs comprised in the first device and the at least two second devices may be different and are independent of each other. That is, the first device may not share a common NN with the at least two second devices. The first device may be configured to optimize or update parameters of its NN purely based on its input and its output during backpropagation in the training phase. Parameter optimization of the NN comprised in the first device may be independent of that of the NNs comprised in the at least two devices. The independent herein shall be understood that devices may not share parameters (i.e., weights and/or biases) of NNs with each other during the training phase. In particular, the first device may not share updated parameters of its NN with any other devices including the at least two second devices during the training phase.

In particular, each NN may comprise an input layer, one or more hidden layers, and an output layer. The input layer may be connected to a subsequent hidden layer of the one or more hidden layers. When the one or more hidden layers comprises two or more hidden layers, all layers of the one or more hidden layers may be connected successively. Moreover, the last hidden layer of the one or more hidden layers may be connected to the output layer. Further, the input layer may be configured to receive an input and provide the input to the subsequent hidden layer for further processing. Further, the one or more hidden layers may be configured to analyze features of the input data. The analysis of the input may be performed layer after layer in the one or more hidden layers. Further, the output layer, also known as the last layer, may be configured to produce an output. In the present disclosure, the output layer and the last layer may be used interchangeably. Likewise, the input and the first layer may also be used interchangeably.

Notably, the NN in the present disclosure may a feed-forward NN. That is, signals between layers of the NN may flow only in one direction in a feed-forward pass: from the input layer, through the one or more successive hidden layers, to the output layer.

Moreover, each layer may comprise a set of neurons. Each neuron may be configured to compute a weighted average of its input, optionally add its bias to obtain a sum. Then, this sum may be passed through a non-linear function, also known as an activation function, to produce its output. A set of outputs of the set of neurons from an output of a layer. The output of each layer may be in a form of a vector, which is also known as an activation vector.

By combining the obtained outputs as an input to the NN comprised in the first device, parts of feature analysis are performed distributively by the at least two second devices. As a result, calculation requirements and bandwidth requirements of the first device may be reduced. Furthermore, efficiency of memory access (i.e., read/write operations) of the first device may be enhanced. Moreover, an arbitrary number of data sources may be used indirectly by the first device via the at least two second devices during the training phase and the inference phase. It is noted that a data source in the present disclosure shall be understood to be configured to provide raw data as an input to a NN during the training phase or the inference phase. The raw data in the present disclosure shall be understood to be unprocessed data provided by the data source. The raw data is also known as source data.

In an implementation form of the first aspect, a size of an input layer of the NN comprised in the first device may be equal to a sum of sizes of output layers of the NNs comprised in the at least two second devices.

In particular, a size of a layer comprised in a NN in the present disclosure shall be understood as the number of neurons comprised in the layer, which may also be equal to the length of a vector processed by the layer, or the length of an output vector of the layer.

Optionally, the first device may be configured to determine the at least two second devices from a pool of candidate second devices based on a length of the raw data. In this way, the first device is capable of handling any raw data of arbitrary length with a fixed-sized input layer.

Optionally, the first device may be configured to determine a quantity of the at least two second devices so as to handle an arbitrary number of data sources that need to be used during the training phase and the inference phase.

In an implementation form of the first aspect, for performing the combining of the obtained outputs, the first device may be configured to concatenate activation vectors of the output layers of the NNs comprised in the at least two second devices.

In particular, the first device may be configured to perform this step as mentioned above in the training phase or the inference phase.

In an implementation form of the first aspect, the first device may be further configured to:
perform backpropagation to obtain an error vector of the input layer of the NN comprised in the first device;
split the obtained error vector based on the sizes of the output layers of the NNs comprised in the at least two second devices accordingly to obtain a set of split error vectors; and
provide the set of split error vectors to the output layers of the NNs comprised in the at least two second devices accordingly, so that the NNs comprised in the at least two second devices are configured to perform backpropagation based on the respective split error vectors accordingly.

In particular, the first device may be configured to perform the above-mentioned steps in the training phase. Backpropagation is a scheme used to optimize parameters of a NN. The parameters may comprise weights and/or biases. Backpropagation may be computed layer after layer, starting from the output layer to the input layer. During backpropagation, for each layer, an error vector may be obtained for each layer, and the parameters of each layer may be adjusted based on the corresponding error vector.

In another implementation of the first aspect, a size of an input layer of the NN comprised in the first device may be equal to a size of each output layer of the NNs comprised in the at least two second devices.

In another implementation of the first aspect, for performing the combining of the obtained outputs, the first device may be configured to perform element-wise summation of activation vectors of the output layers of the NNs comprised in the at least two second devices.

In this way, results of feature analysis performed on the at least two second devices may be summarized during the element-wise summation by the first device. Therefore, the accuracy of a final result may be improved.

In another implementation of the first aspect, the first device may be further configured to:
perform backpropagation to obtain an error vector of the input layer of the NN comprised in the first device; and
broadcast the obtained error vector to each of the at least two devices, so that the NNs comprised in the at least two second devices are configured to perform backpropagation based on the broadcast error vector.

In another implementation of the first aspect, the first device may be a base station or a unit attachable to a base station. Optionally, the first device may be a computing device.

A second aspect of the present disclosure provides a communication network comprising at least two second devices. Each second device comprises a NN, and the at least two second devices are configured to:
respectively obtain an input to the respective NN;
concurrently run the respective NN based on the respective input to obtain outputs; and
respectively provide each output to a first device.

In particular, the at least device may be configured to perform the above-mentioned steps in the training phase or in the inference phase.

Moreover, a quantity of the at least two second device may be configurable based on the number of data sources providing the inputs. In this way, an arbitrary number of data sources may be supported by the communication network.

Further, all devices of the at least two devices may be configured to operate concurrently, not sequentially. That is, operations of the at least two second devices may be independent from each other.

Optionally, parameters of all the NNs comprised in the at least two second devices may be different and are independent of each other. That is, the communication network may be configured not to share the same parameters during parameter optimization. In particular, the at least two second devices may not share a common NN. Each second device may be configured to optimize or update parameters of its NN purely based on its input and its output. Parameter optimization of the NN comprised in each second device may be independent of each other. The independent herein shall be understood that devices may not share parameters (i.e., weights and/or biases) of NNs with each other during the training phase. In particular, each second device may not share updated parameters of its NN with any other devices during the training phase.

In an implementation form of the second aspect, the inputs of the at least two second devices may be distinct. That is, each second device may be configured to process input, i.e., perform a forward pass on its own input. Each of the inputs may be unique. In this way, multithreading processing may be achieved and data processing efficiency may be increased.

In an implementation form of the second aspect, each input of the at least two second devices may be a subset of complete data obtained from a common data source or different data sources.

Optionally, the inputs of the at least two second devices may be used for performing a common task. Further, all the inputs may form a complete piece of information.

Optionally, each input of the at least two second devices may be obtained from different data sources. However, all the inputs may be linked together for the common task.

Optionally, one or more inputs of the at least two second devices may also be one or more outputs of further devices that also comprise further NNs. That is, the at least two second devices may be nested with at least one further second device.

In an implementation form of the second aspect, the at least two second devices may be further configured to:
respectively receive an error vector from the first device; and
respectively perform backpropagation based on the received error vector.

In particular, the received error vectors may be distinct error vectors spilt by the first device based on a size of each output layer of each second device.

Alternatively, the received error vectors may be a same error vector broadcast by the first device.

In an implementation form of the second aspect, one or more parameters of the NNs comprised in the at least two second devices may be different. Further, the one or more parameters may comprise at least one of the following:
the number of layers;
the number of neurons in each layer;
weights; and
biases.

Optionally, the one or more different parameters may be achieved after the training phase and may be kept during the inference phase.

Optionally, all second devices involved during the training phase may be activated during the inference phase at the same time for performing a common task.

In an implementation form of the second aspect, each of the at least two second devices may be a base station or a unit attachable to a base station. Optionally, each of the at least two second devices may be a computing device.

A third aspect of the present disclosure provides a communication system comprising at least one first device according to the first aspect or any implementation form thereof and a communication network according to the second aspect or any implementation form thereof.

In an implementation form of the third aspect, one or more parameters of the NNs comprised in the first device and the at least two second devices may be different. Further, the one or more parameters may comprise at least one of the following:
the number of layers;
the number of neurons in each layer;
weights; and
biases.

Optionally, the one or more different parameters may be achieved after the training phase and may be kept during the inference phase.

A fourth aspect of the present disclosure provides a method performed by a first device for a communication network. The communication network comprises at least two second devices, wherein each of the first device and the at least two second devices comprises a neural network, NN, and wherein the method comprises:
obtaining outputs of the NNs comprised in the at least two second devices;
combining the obtained outputs to generate a combined output;
providing the combined output as an input to the NN comprised in the first device; and
running the NN comprised in the first device based on the input.

In an implementation form of the fourth aspect, a size of an input layer of the NN comprised in the first device may be equal to a sum of sizes of output layers of the NNs comprised in the at least two second devices.

In an implementation form of the fourth aspect, for performing the combining of the obtained outputs, the first device may be configured to concatenate activation vectors of the output layers of the NNs comprised in the at least two second devices.

In an implementation form of the fourth aspect, the first device may be further configured to:
perform backpropagation to obtain an error vector of the input layer of the NN comprised in the first device;
split the obtained error vector based on the sizes of the output layers of the NNs comprised in the at least two second devices accordingly to obtain a set of split error vectors; and
provide the set of split error vectors to the output layers of the NNs comprised in the at least two second devices accordingly, so that the NNs comprised in the at least two second devices are configured to perform backpropagation based on the respective split error vectors accordingly.

In another implementation form of the fourth aspect, a size of an input layer of the NN comprised in the first device may be equal to a size of each output layer of the NNs comprised in the at least two second devices.

In an implementation form of the fourth aspect, for performing the combining of the obtained outputs, the first device is configured to perform element-wise summation of activation vectors of the output layers of the NNs comprised in the at least two second devices.

In an implementation form of the fourth aspect, the first device may be further configured to:
perform backpropagation to obtain an error vector of the input layer of the NN comprised in the first device; and
broadcast the obtained error vector to each of the at least two devices, so that the NNs comprised in the at least two second devices are configured to perform backpropagation based on the broadcast error vector.

In an implementation form of the fourth aspect, the first device may be a base station or a unit attachable to a base station. Optionally, the first device may be a computing device.

A fifth aspect of the present disclosure provides a method for a communication network comprising at least two second devices. Each second device comprises a NN. The method comprises:
respectively obtain an input for the respective NN;
concurrently run the respective NN based on the respective input to obtain outputs; and
respectively provide each output to a first device.

In an implementation form of the fifth aspect, the inputs of the at least two second devices may be distinct.

In an implementation form of the fifth aspect, each input of the at least two second devices may be a subset of a complete data obtained from a common data source or from different data sources.

In an implementation form of the fifth aspect, the at least two second devices may be further configured to:
respectively receive an error vector from the first device; and
respectively perform backpropagation based on the received error vector.

In an implementation form of the fifth aspect, one or more parameters of the NNs comprised in the at least two second devices may be different. The one or more parameters comprise at least one of the following:
the number of layers;
the number of neurons in each layer;
weights; and
biases.

In an implementation form of the fifth aspect, each of the at least two second devices is a base station or a unit attachable to a base station.

A sixth aspect of the present disclosure provides a method for training NNs comprised in a first device and at least two second devices. The method comprising the following steps:
respectively obtaining, by the at least two second devices, an input for the respective NN;
concurrently running, by the at least two second devices, the respective NN based on the respective input to obtain outputs;
respectively providing, by the at least two second devices, each output to the first device;
obtaining, by the first device, the outputs of the NNs comprised in the at least two second devices;
combining, by the first device, the obtained outputs to generate a combined output;
providing, by the first device, the combined output as an input to the NN comprised in the first device;
running, by the first device, the NN comprised in the first device based on the input;
obtaining, by the first device, an output of the NN comprised in the first device;
performing, by the first device, backpropagation to optimize parameters of the NN comprised in the first device based on the obtained output of the NN comprised in the first device, and to obtain an error vector of an input layer of the NN comprised in the first device;
providing, by the first device, the error vector to the at least two devices;
respectively receiving, by the at least two second devices, a respective error vector from the first device; and
respectively performing, by the at least two second devices, backpropagation based on the received error vector to optimize parameters of the respective NN.

A seventh aspect of the present disclosure provides a computer program product. The computer program product comprises a program code for performing the method according to the fourth aspect or any implementation form thereof, when executed on a computer.

A eighth aspect of the present disclosure provides a computer program product. The computer program product comprises a program code for performing the method according to the fifth aspect or any implementation form thereof, when executed on a computer.

A ninth aspect of the present disclosure provides a computer program product. The computer program product comprises a program code for performing the method according to the sixth aspect, when executed on a computer.

A tenth aspect of the present disclosure provides a non-transitory storage medium storing executable program code which, when executed by a processor, causes the method according to the fourth aspect or any implementation form thereof, or the fifth aspect or any implementation form thereof, or the sixth aspect to be performed.

A eleventh aspect of the present disclosure provides a chipset comprising a memory and a processor, which are configured to store and execute program code to perform the method according to the fourth aspect or any implementation form thereof, or the fifth aspect or any implementation form thereof, or the sixth aspect.

It has to be noted that all devices, elements, units, and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity, which performs that specific step or functionality, it should be clear for a skilled person that these methods and functionalities can be implemented in respective software or hardware elements, or any kind of combination thereof.

### BRIEF DESCRIPTION OF DRAWINGS

The above-described aspects and implementation forms will be explained in the following description of specific embodiments in relation to the enclosed drawings, in which

FIG. 1 shows an exemplary architecture of a NN;

FIG. 2 shows a detailed exemplary architecture of a NN;

FIG. 3 shows a first device according to an embodiment of the invention, and a communication network according to an embodiment of the invention;

FIG. 4 shows a first device according to another embodiment of the invention, and a communication network according to another embodiment of the invention;

FIG. 5 shows a communication system according to an embodiment of the invention;

FIG. 6 shows an application scenario according to an embodiment of the invention;

FIG. 7 shows a diagram of a data flow of a communication system according to an embodiment of the invention;

FIG. 8 shows a diagram of a method according to an embodiment of the invention;

FIG. 9 shows a diagram of a method according to an embodiment of the invention; and

FIG. 10 shows a diagram of a method according to an embodiment of the invention;

### DETAILED DESCRIPTION OF EMBODIMENTS

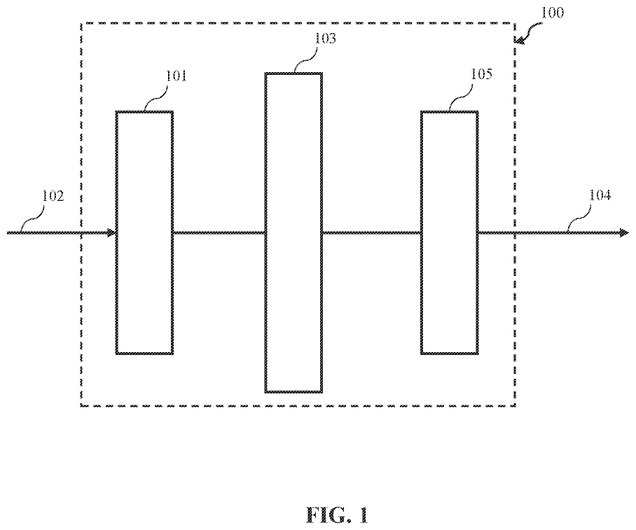

FIG. 1 shows an exemplary architecture of a NN 100 for embodiments of the invention.

As shown in FIG. 1, the NN 100 comprises an input layer, an output layer, and at least one hidden layer between the input layer and the output layer. The output layer is also known as the last layer. It is noted that although only one hidden layer is shown in FIG. 1, the NN may comprise a plurality of successive hidden layers. For a given input 102, the NN 100 may be configured to produce an output 104.

For the sake of simplicity, only a total of three layers is illustrated in FIG. 1. However, FIG. 1 shall not be interpreted to impose a limitation to the number of layers in the NN in the this disclosure. In particular, the NN may comprise any reasonable number (≥3) of layers for performing a specific task. The determination of the specific number belongs to common general knowledge in the field and is not relevant to this disclosure. Therefore, it is not discussed in detail herein.

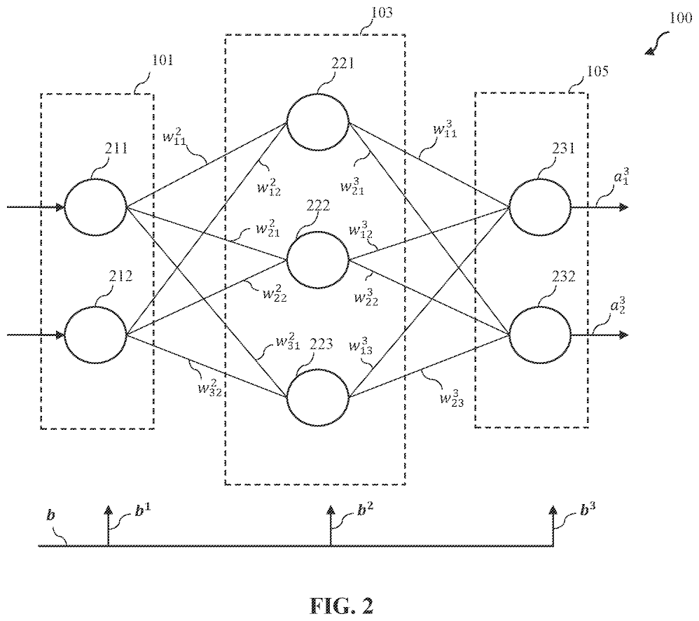

FIG. 2 shows a detailed architecture of a NN 100 for embodiments according to the invention. The above description with respect to FIG. 1 is correspondingly valid for FIG. 2. Furthermore, the following features described with respect to FIG. 2 may also be applied likewise to the features mentioned with respect to FIG. 1.

As shown in FIG. 2, each layer (the input layer, the hidden layer, the output layer) may comprise one or more neurons. Furthermore, each neuron of a layer may be connected to all neurons of a subsequent layer. Each connection between two neurons of two adjacent layers may correspond to a weight. Optionally, each neuron itself may be associated with a bias. Parameters of the NN may comprise the weights and the optional biases.

It is noted that the following notation is used in the present disclosure unless otherwise defined:
l may denote a numbering of layers in the NN, which correspond to lₜₕ layer in the NN starting from the input layer to the output layer. l is an integer from 1 to L;
may denote the number of layers in the NN. L is an integer larger than 2. The value of L is a constant for a specific NN;
i, j, k may denote a numbering of neurons in each layer, which corresponds to tₜₕ/jₜₕ/kₜₕ
neuron in each layer, starting from the first neuron to the last neuron in each layer. i, j, k are all positive integers, and are from 1 to the number of neurons in each layer;
wⱼₖ^{l} may denote a weight for the connection from the k^{th} neuron in the (1−1)^{th} layer to the j^{th} neuron in the l^{th} layer, l>1. wⱼₖ^{l} maybe any value, and the value is changeable during the training phase;
bⱼ^{l} may denote a bias of j^{th} neurons in l^{th} layer. bⱼ^{l} maybe any value, and the value is changeable during the training phase; and
aⱼ^{l} may denote an activation (output) of j^{th} neurons in l^{th} layer. aⱼ^{l} maybe any value, and the value is determined according to an activation function.

For an un-trained NN, values of weights, as well as biases if present, may be assigned randomly, or assigned with a fixed value, or assigned according to an initialization algorithm. The training phase may be understood as a process to achieve an optimal combination of weights and/or bias of the NN for performing a specific task through learning. In particular, backpropagation may be used during the training phase.

Further, for each input, the NN is configured to produce an output. For achieving the output, the input may traverse all layers of the trained NN and may be analyzed layer after layer from the input layer, through the at least one hidden layer, till the output layer, which is also known as a feed-forward pass. This feed-forward pass is shared by the training phase and the inference phase.

Notably, the output may have a form of a vector, among which the largest value may denote the most promising label indicating a class of the input. That is, a decision is made by the NN.

As shown in FIG. 2, in this example, the input layer as the first layer may comprise two neurons; the hidden layer as the second layer may comprise three neurons; the output layer as the third layer may comprise two neurons. According to the natation mentioned above, neuron 2lj denotes the j^{th} neuron in l^{th} layer. For example, neuron 232 in FIG. 2 denotes the second neuron in the third layer.

It is noted that the number of layers and the number of neurons in each layer depicted in FIG. 2 are simplified for illustration purposes only. They shall not be understood to impose a limitation on the NN for embodiments of the present disclosure. Moreover, the number of layers, the number of neurons in each layer may be determined by the skilled person based on common general knowledge, which is not described in more detail herein.

Each neuron may be configured to take the output of another neuron in a previous layer, add its bias if applicable as the input, and apply an activation function to the input. The activation function may be one of the following: a Sigmoid function, a Hyperbolic Tangent function, a Rectified Linear Unit (ReLU) function, a Leaky ReLU function, a parametric ReLU function, a Softmax function, and a Swish function. It is noted that the above list of activation functions is non-exhaustive and does not exclude any other activation functions that may be used by the skilled person in the field. Furthermore, embodiments of the present disclosure may not be limited to a certain type of activation function. In the following, the activation function is denoted as σ(⋅).

By using the above-mentioned notations, an input of a neuron may be denoted as:

zⱼ^{l}=Σₖwⱼₖ^{l}·aₖ^{l-1}+bⱼ^{l}, (1)

and an activation (or output) of a neuron may be denoted as:

aⱼ^{l}=σ(Σₖwⱼₖ^{l}·aₖ^{l-1}+bⱼ^{l}), or simply,

aⱼ^{l}=σ(zⱼ^{l}) (2)

wherein zⱼ^{l} denotes the input of the j^{th} neuron in the l^{th} layer.

Moreover, by vectorizing the activation function σ(·), the equation (2) may be written in a matrix form as:

a^{l}=σ(w^{l}a^{l-1}+b^{l}), (3)

wherein a^{l}=[a₁^{l} . . . aⱼ^{l}]^{T}, T denotes transpose.

Furthermore, for vectorizing the activation function, the following notion may be applied:

σ(s)ₘ=σ(sₘ).

For example, a vectorized function f(x)=x² may have the effect that:

$$f ( [ \begin{matrix}3 \\ 4\end{matrix} ] ) = [ \begin{matrix}f ( 3 ) \\ f ( 4 )\end{matrix} ] = [ \begin{matrix}9 \\ 16\end{matrix} ] .$$

When a layer is the output layer, its activation a^{L} may be regarded as the output of the NN. For the example in FIG. 2, the output may be denoted as a³=[a₁³ a₂³]^{T}.

One goal of backpropagation is to compute partial derivatives of a cost function with respect to weights or biases of the NN starting from the last layer back to the input layer, so that weights and bias may be optimized during the training phase.

For performing backpropagation, the device may be configured to determine the cost function C. For example, the cost function may be one of a mean squared error (MSE, also known as quadratic) cost function, a mean absolute error cost function, a Huber cost function, a Hinge cost function, a cross-entropy function, and a Kullback-Leibler function.

For example, the cost function C may be the MSE cost function as:

$$C = \frac{1}{2} {‖ t - {a}^{L} ‖}^{2} = \frac{1}{2} {\sum }_{j} {( {t}_{j} - {a}_{j}^{L} )}^{2} , \qquad ( 4 )$$

wherein t is the ground truth corresponding to the input. The input may be a training sample that may be labeled, i.e., a desired output. t may be the ground-truth value according to that desired output.

After defining the cost function and the ground truth, errors of the output layer may be computed as:

δ^{L}=ΔₐC⊚σ′(z^{L}), (5)

wherein δ^{L} denotes the error of the output layer, ΔₐC denotes a vector whose components are the partial derivatives

$$\frac{\partial C}{\partial {a}_{j}^{L}} ,$$

⊚ denotes elementwise product of two vectors, also known as Hadamard product or Schur product, and σ′ is a derivative of the activation function σ.

Further, when the cost function is defined as equation (5), equation (6) may have a form of:

δ^{L}=(a^{L}−t)⊚σ′(z^{L}). (6)

Moreover, the gradients of each layer may comprise partial derivatives of the cost function with respect to the weights of each layer, i.e.,

$$\frac{\partial C}{\partial {w}_{jk}^{l}} .$$

The obtained gradients may be in a form of a vector or a matrix.

Moreover, the gradients of each layer may further comprise partial derivatives of the cost function with respect to the output of each layer, i.e.

$$\frac{\partial C}{\partial {a}_{j}^{l}} .$$

Based on the chain rule in calculus, the following formula may be obtained:

$$\frac{\partial C}{\partial {w}_{jk}^{l}} = {a}_{k}^{l - 1} \cdot {δ}_{j}^{l} \qquad ( 7 )$$

Likewise, if the NN comprises the optional biases b, the gradients of each layer may further comprise partial derivatives of the cost function with respect to the biases of each layer of the subgroup of the one or more layers, i.e.,

$$\frac{\partial C}{\partial {b}_{j}^{l}} .$$

The obtained gradients may be in a form of a vector or a matrix.

Without losing generality, the above mentioned features, as well as other common general knowledge in the field, may be applied to the present disclosure.

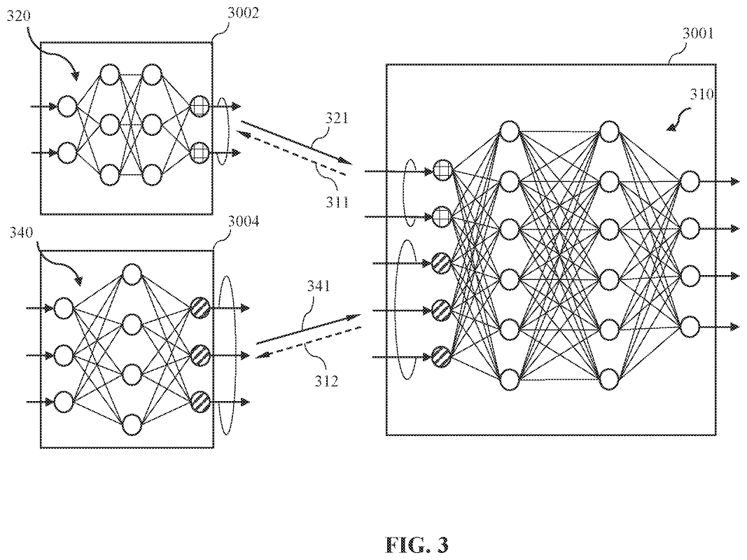

FIG. 3 shows (on the right-hand side) a first device 3001 according to an embodiment of the invention, and shows (on the left-hand side) a communication network according to an embodiment of the invention.

The communication network comprises at least two second devices 3002, 3004. Each device 3001, 3002, 3004 comprises a NN 310, 320, 340. The NNs 310, 320, 340 comprised in the first device 3001 and in the at least two second devices 3002, 3004 are built based on the NN described with respect to FIGS. 1-2 and shall share similar features as mentioned in FIGS. 1-2. Further, all the NNs 310, 320, 340 may not share the same structure or the same parameters. The first device and the at least two devices may be connected via a wired connection or a wireless connection.

In the communication network, each second device 3002, 3004 obtains its input for its NN 320, 340, respectively. The input may be raw data from a data source, or an output of a further NN comprised in a further device. Moreover, an arbitrary number of data sources may be used. For example, if the communication network comprises two second devices, the second devices may be configured to obtain inputs from two data sources respectively. Alternatively, one second device may be configured to obtain its input from a data source, while the other second device may be configured to obtain its input from an output of a further NN comprised in a further device. A specific number of data sources is not limited herein.

After obtaining the inputs, the at least two second devices 3002, 3004 are configured to operate concurrently or simultaneously, i.e., not sequentially, in order to obtain outputs 321, 341, respectively. That is, the NNs comprised in the at least two second devices are executed concurrently. In particular, a feed-forward pass may be performed for each NN 320, 340 based on each input. The outputs 321, 341 of the NNs 320, 340 may be independent, i.e., one output does not rely on any other output of the NNs 320, 340.

Then, the at least two second devices 3002, 3004 are configured to provide the outputs 321, 341 to the first device 3001, respectively.

After obtaining the outputs 321, 341, the first device 3001 is configured to combine the obtained outputs 321, 341 and provide the combined output as an input to the NN 310 comprised in the first device 3001. Then, the first device 3001 is configured to execute the NN 310 based on the input. In particular, a feed-forward pass may be performed on the NN 310 based on the input.

It is noted that the feed-forward passes as mentioned above may be performed in both the training phase and the inference phase.

Furthermore, during the training phase, backpropagation may be preferably performed across the first device 3001 and the at least two second devices 3002, 3004, so that parameters of all the NNs 310, 320, 340 may be optimized. It is noted that backpropagation is not illustrated inside the NNs 310, 320, 340 in FIG. 3 for the sake of simplicity. However, details regarding backpropagation are widely known or form part of common general knowledge in the field. Therefore, backpropagation is not described in detail herein.

In particular, during backpropagation, the first device 3001 may be configured to provide an error vector of the input layer of the NN 310 to the at least two second devices 3002, 3004, respectively. Then, the at least two second devices 3002, 3004 may provide the error vector to the output layers of the NNs 320, 340 so as to continue backpropagation.

In a possible embodiment, a size of an input layer of the NN 310 comprised in the first device 3001 may be equal to a sum of sizes of output layers of the NNs 320, 340 comprised in the at least two second devices 3002, 3004, as illustrated exemplarily in FIG. 3. Specific sizes of the input layer and the output layer shall not be limited herein.

In this embodiment, for combining the outputs 321, 341, the first device 3001 may concatenate the outputs 321, 341. In particular, the outputs 321, 341 may be in forms of vectors. A combined output may be a concatenated vector. The first device 3001 may use this concatenated vector as the input for its NN.

Moreover, during backpropagation, the first device 3001 may split the error vector of the input layer of its NN 310 according to the sizes of the output layers of the NNs 320, 340 comprised in the at least two second devices. Then, the first device 3001 may provide the split error vectors 311, 312 to the at least two second devices 3002, 3004, respectively.

After obtaining the split error vectors 311, 312, the at least two devices 3002, 3004 may continue backpropagation based on the spilt error vectors on their NNs 320, 340, respectively.

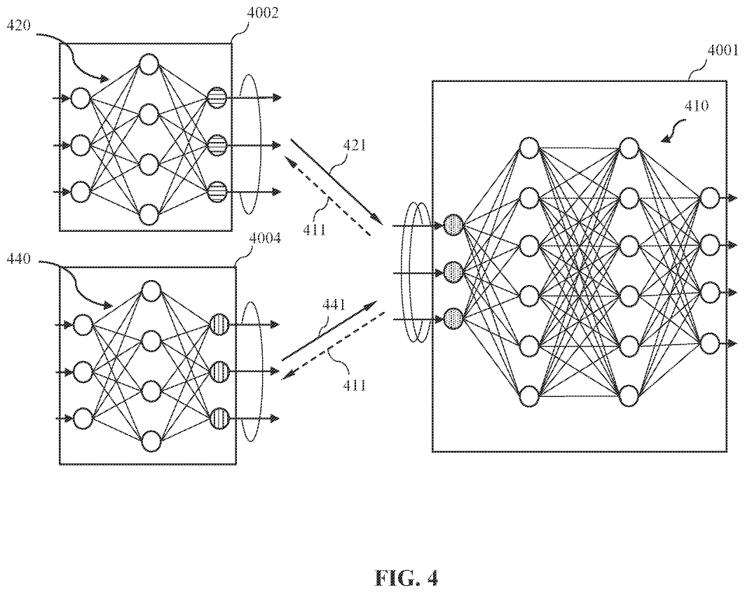

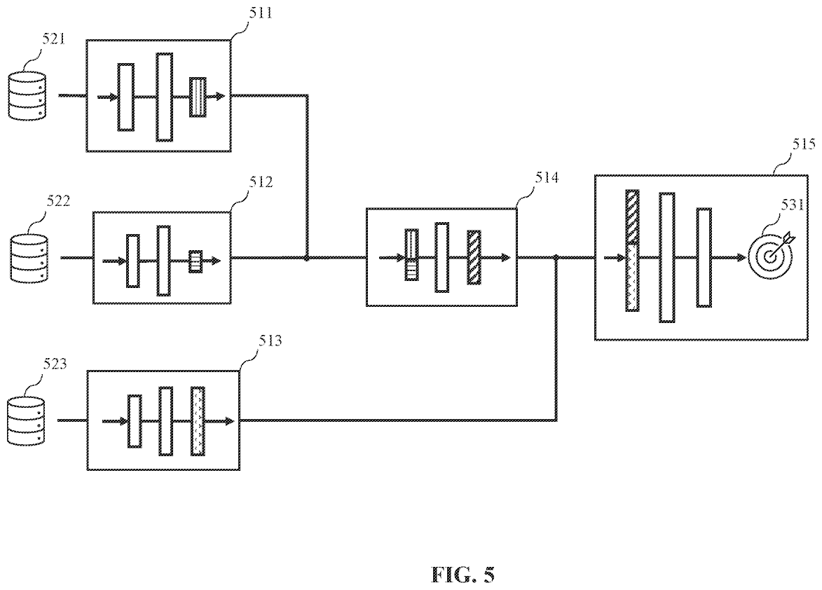

FIG. 4 shows (on the right-hand side) a first device 4001 according to another embodiment of the invention, and shows (on the left-hand side) a communication network according to another embodiment of the invention. The communication network in this embodiment comprises at least two second devices 4002, 4004. Elements in FIG. 4 are built based on similar elements in FIG. 3. Similar elements shall share similar features unless otherwise defined.

It is noted that the feed-forward pass and backpropagation performed internally inside each NN comprised in the first device and the at least two second device shall share the same features as described with respect to FIGS. 1-3.

In this embodiment, a size of an input layer of the NN 410 comprised in the first device 4001 is equal to a size of each output layer of the NNs 420, 440 comprised in the at least two second devices 4002, 4004. For illustration purposes only, FIG. 4 shows exemplarily that the sizes of the concerned layers are all equal to three. However, specific sizes of the input layer and the output layers shall not be limited herein.

Furthermore, for combining the outputs 421, 441, the first device 4001 may perform element-wise summation of the outputs, i.e., activation vectors 421, 441 of the output layers of the NNs 420, 440. Optionally, the first device may perform normalization on the sum of the activation vectors.

Then, the first device may use the sum as the input to its NN 410 for execution. In particular, a feed-forward pass may be executed for the NN 410 based on the input.

Furthermore, during backpropagation, the first device 4001 may broadcast an obtained error vector 411 of the input layer of its NN 410 to each of the at least two devices 4002, 4004. Then, the at least two devices 4002, 4004 may provide the broadcast error vector 411 to the output layer of respective NN 420, 440 so as to continue backpropagation.

In all the above-mentioned embodiments, more than one NN is involved, i.e., trained and deployed, distributively across devices for a common task. Moreover, the involved NNs may have distinct architectures and parameters such as weights or biases. The involved NNs of the at least two second devices may be executed concurrently during the inference phase. It may have an effect that an amount of exchanged data between distributed devices per epoch may be significantly reduced. Because due to the distinct architecture and/or parameters across all NNs, each NN may be trained independently. Only the activation vectors of output layers or error vectors of input layers may be communicated between devices. Furthermore, each NN may also be executed during the inference phase and may be configured to perform feature analysis on distinct aspects. Therefore, a total amount of data exchanged for an epoch may be significantly reduced. Moreover, bandwidth per epoch and memory access may also be reduced. It may also benefit a communication network or a communication system that comprise any of the devices, because bandwidth requirement of the network or system may be decreased both for the training phase and the interface phase. Notably, one epoch means that each training sample in a training dataset has had an opportunity to update parameters of a NN.

Moreover, an arbitrary number of data sources may be used for performing the common task by determining a corresponding number of the second devices. Therefore, flexibility may be introduced into the communication network or system that comprises any of the devices.

FIG. 5 shows a communication system according to an embodiment of the invention. Elements in FIG. 5 are built based on FIGS. 1-4. Therefore, similar elements in FIGS. 1-5 shall share the same functions and features likewise.

As exemplarily shown in FIG. 5, the communication system comprises at least one first device, and at least two second devices. All devices in the communication system comprise an NN. From one point of view, the first device may be device 514, while the at least two second devices may be devices 511 and 512. From another point of view, the first device may be device 515, while the at least two second devices may be devices 513 and 514. Therefore, the notion of the first device and the second device in the present disclosure may be relative and may be dependent on the position and relationship of a device with other devices. For example, as shown in FIG. 5, devices 511, 512, 513 can only function as second devices and may be configured to obtain inputs from data sources 521, 522, 523. The device 514 may function as a first device as well as a second device. The device 515 that makes a final decision 531 can only function as a first device.

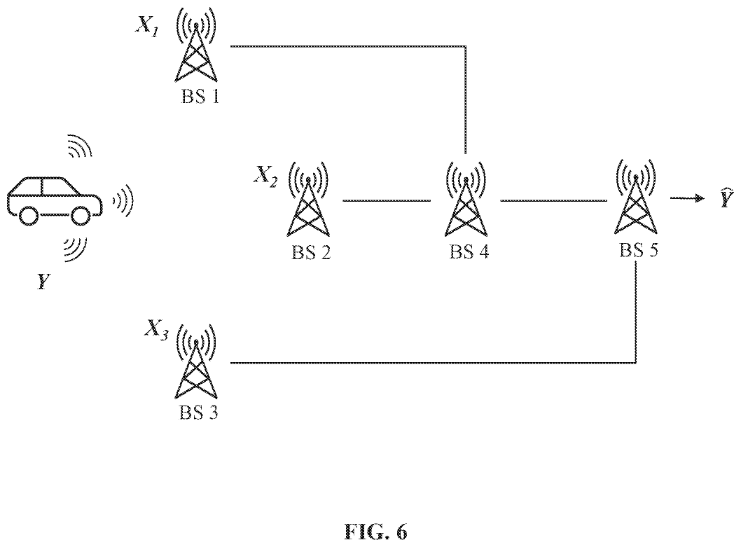

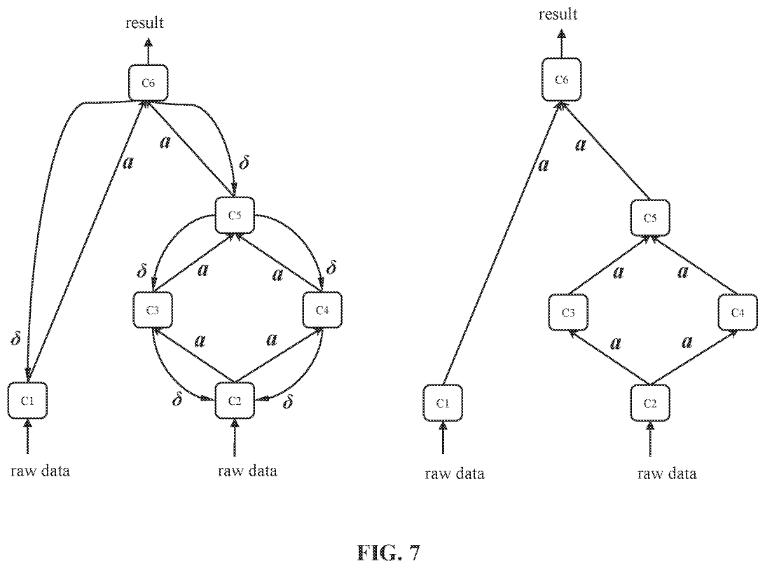

FIG. 6 shows an application scenario according to an embodiment of the invention. Elements in FIG. 6 are built based on the elements comprised in FIGS. 1-5. Therefore, similar elements in FIGS. 1-6 shall share the same functions and features likewise.

FIG. 6 shows exemplarily a communication system comprising five base stations (BSs), BS1-BS5 . Each of the five base stations (BSs) comprises a NN, NN1-NN4 (not shown in FIG. 5). The five BSs are arranged similarly to the five devices in FIG. 5. In particular, BS 1 and BS 2 may communicate with BS 4, and BS 3 and BS 4 may communicate with BS 5. BS 5 may be configured to make a final decision.

In this application scenario, the communication system may be configured to perform positioning based on channel state information (CS) signals received from a user by multiple BSs. In the example shown in FIG. 6, the user, such as a car, may be moving from an area of BS1, via an area of BS2, to an area of BS3. Signals X₁, X₂, and X₂ sent from the user may be collected by BS1, BS2, and BS3 in each region, respectively. The final decision made in BS5 may comprise at least one of the following: location, speed, and altitude of the user. It is noted that neural networks may be widely known for classification. The task of positioning in this application scenario may also be viewed as a sort of classification, because the NNs in this application may be configured to identify one location among a set of locations in an area based on the CSI signal.

Further, the communication between BSs may be based on orthogonal frequency-division multiplexing (OFDM). In particular:
K₁₄ subcarriers are used for communication between BS1 and BS4;
K₂₄ subcarriers are used for communication between BS2 and BS4;
K₃₅ subcarriers are used for communication between BS3 and BS5; and
K₄₅ subcarriers are used for communication between BS4 and BS5.

Correspondingly, the five BSs may comprise NNs such that:
NN1 at BS1 comprises an input layer with a size of a length of the signal X₁ and an output layer with a size of K₁₄;
NN2 at BS2 comprises an input layer with a size of a length of the signal X₂ and an output layer of size K₂₄;
NN3 at BS3 comprises an input layer with a size of a length of the signal X₃ and an output layer of size K₃₅;
NN4 at BS4 comprises an input layer with a size of K₁₄+K₂₄ and output layer with a size of K₄₅; and
NN5 at BS5 comprises an input layer with a size of K₃₅+K₄₅.

For training the NN1-NN5, a training dataset may be used. Specifically, the training dataset may be a publicly available dataset that is suitable for the particular task, in this case, positioning based on CSI signals. Alternatively, a training dataset may be manually created by collecting CSI signals at various locations with various speeds in the coverage areas of BS1-BS3. User location, altitude, and speed Y may be logged and labeled corresponding to each location and each collected CSI signal. Furthermore, the training dataset may be partitioned according to the sizes of the input layers of NN1, NN2, and NN3.

One round of a forward pass during the training phase may comprise the following steps.
Firstly, BS1, BS2, and BS3 concurrently obtain input raw data from the training dataset, and then concurrently perform a forward pass based on the input data.
Secondly, BS1, BS2, and BS3 provide the activation vectors of the output layers of NN1, NN2, and NN3 to BS4, BS4, and BS5, respectively.
Thirdly, BS 4 combines the activation vectors of the output layers of NN1 and NN2 as an input to NN4, executes a forward pass of NN4 based on the combined activation vector, and provides the activation vector of the output layer of NN4 to BS5.
Then, BS5 combines the activation vectors of the last layers of NN3 and NN4 as an input to NN5, executes a forward pass of NN5 based on the input, and produces an output indicating a result Ŷ.

It is noted that the above-mentioned forward pass may be similarly executed once by receiving respective input by BS1, BS2, and BS3 in the inference phase. The inputs may be collected from a real user by BS1, BS2, and BS3 in a real application scenario. It is noted that although the inputs may be collected from a particular user, it may still be interpreted that inputs collected from the user but at different locations and/or different time points may still be seen as collected from different data sources. Nevertheless, it should be understood that raw data collected as inputs may be distinct and may be used collectively for a common task. Each raw data is a piece of sub-information belonging to a complete piece of information that may be used by one or more NNs for the common task.

Then, for the training phase, backpropagation may be performed to compute error vectors of each layer in a NN. These error vectors may be used to adjust parameters of a NN.

In particular, one round of backpropagation may comprise the following steps.
Firstly, based on the result Ŷ, BS5 may compute an error vector for the output layer, and then execute a backward pass by back-propagating the error vector from the output layer to the last layer. For example, the error vector for the output layer may be determined according to a loss function regarding ∥Ŷ−Y∥. During the backward pass, an error vector may be obtained for each layer, and parameters in each layer may be adjusted based on the error vector. In the end, BS5 obtains an error vector of the input layer of NN5 with a size of K₃₅+K₄₅. Then, BS5 may split the error vector of the input layer into sub-vectors according to the sizes of output layers of NN3 and NN4, i.e., two sub-vectors with a size of K₃₅, K₄₅, respectively. Then, BS5 may send the sub-vector with size K₃₅ to BS3, and send the sub-vector with size K₄₅ to BS4.
Secondly, after receiving the respective sub-vector, BS3 and BS4 may provide the received sub-vectors to the output layers of NN3 and NN4, respectively. Then, similar to BS5, BS3 and BS 4 may adjust parameters by performing a backward pass by back-propagating the respective sub-vector from the output layer to the input layer, respectively in NN3 and NN4. In the end, BS4 may obtain an error vector of the input layer of NN4 with a size of K₁₄+K₂₄. Then, BS4 may split the error vector of the input layer of NN4 into two sub-vectors with a size of K₁₄+K₂₄, respectively. Then, BS4 may send the sub-vector with size K₁₄ to BS1, and send the sub-vector with size K₂₄ to BS2.
Finally, after receiving the respective sub-vector, BS1 and BS2 may provide the received sub-vectors to the output layers of NN1 and NN2, respectively. Then, similar to BS3-BS4, BS1 and BS2 may adjust parameters by performing a backward pass by back-propagating the respective sub-vector from the output layer to the input layer, respectively in NN1 and NN2.

It is noted that the above-mentioned forward pass and backpropagation may continue by using other training samples in the training dataset. Moreover, the above-mentioned forward pass and backpropagation may continue and may be repeated until convergence. For example, one commonly used algorithm to achieve optimal parameters is gradient descent.

Moreover, although a base station is illustrated in this embodiment to refer to a first device or a second device. It shall be understood that the first device and the second device are not limited to a base station. In some other embodiments of the invention, each of the first device and the second device may also be a unit attachable to a base station. Alternatively or additionally, each of the first device and the second device may be a computing device, such as a computer, a server blade, a computer cluster, a virtual machine based on computer architectures, a tablet, a graphics processing unit, or the like.

FIG. 7 shows a diagram of a data flow of a communication system according to an embodiment of the invention.

FIG. 7 shows on the left-hand side a data flow of the communication system in the training phase, and a further data flow of the communication system in the inference phase on the right-hand side. Nodes C1-C6 may denote devices, and each device may comprise a NN. It is noted that labels of “raw data”, “result”, a, and δ marked in FIG. 6 are merely used to indicate a type of data transmitted between nodes, and do not indicate the same value. In particular, a indicates an activation vector of an output layer of each NN in each node in a feedforward pass, while δ indicates an error vector of an input layer of each NN in each node in backpropagation. Elements in FIG. 7 are built based on the elements comprised in FIGS. 1-6. Therefore, similar elements in FIGS. 1-7 shall share the same functions and features likewise.

As shown in FIG. 7, if considering C6 functioning as a first device, then C1 and C5 may be considered as the at least two devices. Furthermore, if considering C5 as a first device, then C3 and C5 may be considered as the at least two devices. Moreover, C2 is connected to C3 and C4 simultaneously. In this case, by applying the same features as mentioned in FIG. 3 or FIG. 4 but in a reversed manner, C2 may be configured to either split or broadcast its activation vector of the output layer of its NN to C3 and C4 in a feedforward pass, depending on a size of the output layer of the NN in C2 and sizes of the input layers of the NNs in C3 and C4. Backpropagation from C3 and C4 to C2 may be a reverse procedure with respect to the feedforward pass.

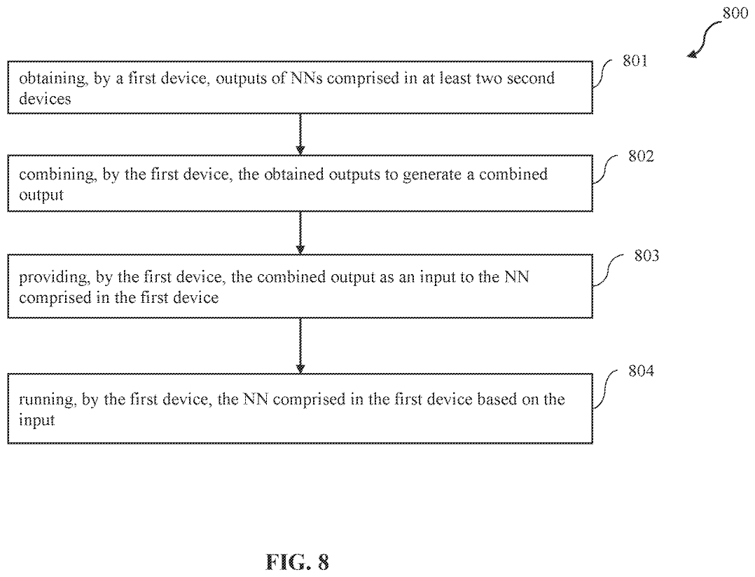

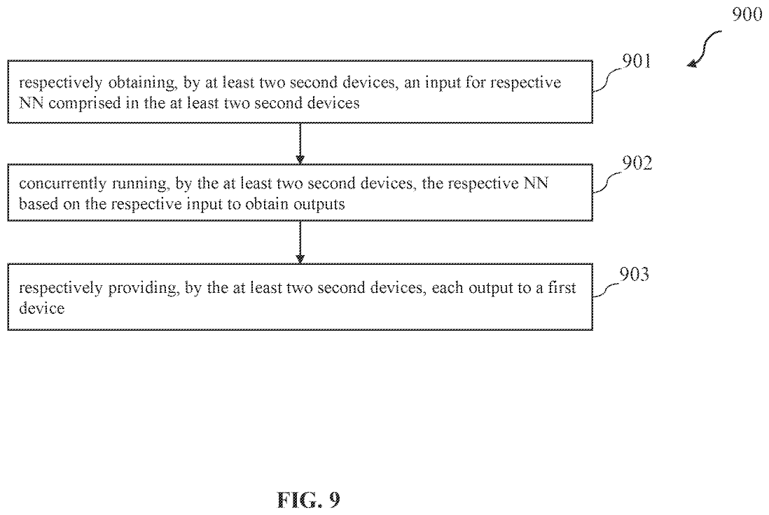

FIG. 8 shows a diagram of a method 800 according to an embodiment of the invention. The method 800 is performed by a first device for a communication network, wherein the communication network comprises at least two second devices. Each of the first device and the at least two second devices comprises a NN. The method 800 comprises the following steps:
step 801: obtaining outputs of the NNs comprised in the at least two second devices;
step 802: combining the obtained outputs to generate a combined output;
step 803: providing the combined output as an input to the NN comprised in the first device; and
step 804: running the NN comprised in the first device based on the input.

The steps of the method 800 may share the same functions and details from the perspective of FIGS. 1-7 described above. Therefore, the corresponding method implementations are not described again at this point.

FIG. 9 shows a diagram of a method 900 according to an embodiment of the invention. The method 900 is for a communication network comprising at least two second devices. Each second device comprises a NN. The method 900 is performed by the at least two devices and comprises the following steps:
step 901: respectively obtaining an input for the respective NN;
step 902: concurrently running the respective NN based on the respective input to obtain outputs; and
step 903: respectively providing each output to a first device.

The steps of the method 900 may share the same functions and details from the perspective of FIGS. 1-7 described above. Therefore, the corresponding method implementations are not described again at this point.

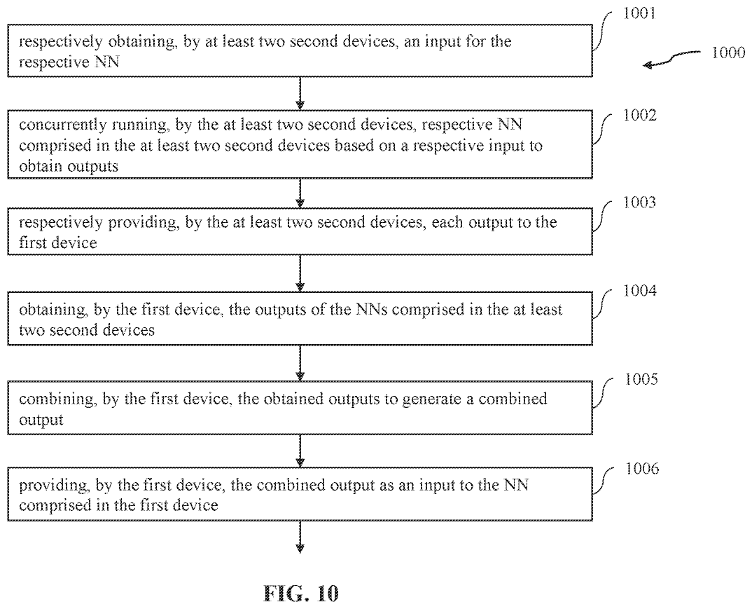

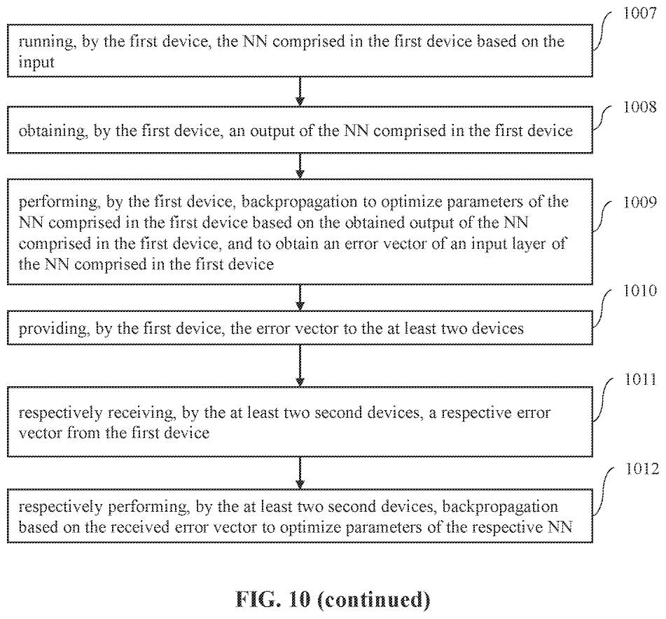

FIG. 10 shows a diagram of a method 1000 according to an embodiment of the invention. The method 1000 is for training NN comprised in a first device and at least two second devices. The method 1000 comprises the following steps:
step 1001: respectively obtaining, by the at least two second devices, an input for the respective NN;
step 1002: concurrently running, by the at least two second devices, the respective NN based on the respective input to obtain outputs;
step 1003: respectively providing, by the at least two second devices, each output to the first device;
step 1004: obtaining, by the first device, the outputs of the NNs comprised in the at least two second devices;
step 1005: combining, by the first device, the obtained outputs to generate a combined output;
step 1006: providing, by the first device, the combined output as an input to the NN comprised in the first device;
step 1007: running, by the first device, the NN comprised in the first device based on the input;
step 1008: obtaining, by the first device, an output of the NN comprised in the first device;
step 1009: performing, by the first device, backpropagation to optimize parameters of the NN comprised in the first device based on the obtained output of the NN comprised in the first device, and to obtain an error vector of an input layer of the NN comprised in the first device;
step 1010: providing, by the first device, the error vector to the at least two devices;
step 1011: respectively receiving, by the at least two second devices, a respective error vector from the first device; and
step 1012: respectively performing, by the at least two second devices, backpropagation based on the received error vector to optimize parameters of the respective NN.

In particular, the first device and the at least two second devices may form a communication system, and may be connected with a wired or a wireless connection.

The steps of the method 1000 may share the same functions and details from the perspective of FIGS. 1-7 described above. Therefore, the corresponding method implementations are not described again at this point.

It is noted that the first device 3001, 4001 and the second device 3002, 3004, 4002, 4004 in the present disclosure may comprise processing circuitry (not shown) configured to perform, conduct or initiate the various operations of the first apparatus 3001, 4001 and the second apparatus 3002, 3004, 4002, 4004 described herein, respectively. The processing circuitry may comprise hardware and software. The hardware may comprise analog circuitry or digital circuitry, or both analog and digital circuitry. The digital circuitry may comprise components such as application-specific integrated circuits (ASICs), field-programmable arrays (FPGAs), digital signal processors (DSPs), or multi-purpose processors. In one embodiment, the processing circuitry comprises one or more processors and a non-transitory memory connected to the one or more processors. The non-transitory memory may carry executable program code which, when executed by the one or more processors, causes the first apparatus 3001, 4001 and the second apparatus 3002, 3004, 4002, 4004 to perform, conduct or initiate the operations or methods described herein, respectively.

In some embodiments, each of the first apparatus 3001, 4001 and the second apparatus 3002, 3004, 4002, 4004 may be an electronic device capable of computing, such as a computer, a server blade, a computer cluster, a virtual machine based on computer architectures, a tablet, a graphics processing unit, and the like.

Moreover, a type of neural network in the present disclosure is not limited. For example, the neural network in the present disclosure may be a feedforward neural network, a convolutional neural network, a recurrent neural network, a deep neural network, or the like. Moreover, neurons of the neural network may be fully connected, or partially connected. In principle, embodiments of the present disclosure may be applied to any type of a neural network that produces an output corresponding to an input.

Moreover, the training process used in embodiments of the invention may be either supervised or unsupervised.

The present disclosure has been described in conjunction with various embodiments as examples as well as implementations. However, other variations can be understood and effected by those persons skilled in the art and practicing the claimed matter, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

What is claimed is:

1. A first device (3001; 4001) for a communication network, wherein the communication network comprises at least two second devices (3002, 3004; 4002, 4004), wherein each of the first device (3001; 4001) and the at least two second devices (3002, 3004; 4002, 4004) comprises a neural network, NN (310; 410; 320, 340; 420, 440), and wherein the first device (3001; 4001) is configured to:
obtain outputs (321, 341; 421, 441) of the NNs (320, 340; 420, 440) comprised in the at least two second devices (3002, 3004; 4002, 4004);
combine the obtained outputs (321, 341; 421, 441) to generate a combined output;
provide the combined output as an input to the NN (310; 410) comprised in the first device (3001; 4001); and
run the NN (310; 410) comprised in the first device (3001; 4001) based on the input.

2. The first device (3001) according to claim 1, wherein a size of an input layer of the NN comprised in the first device (3001) is equal to a sum of sizes of output layers of the NNs (320, 340) comprised in the at least two second devices (3002, 3004).

3. The first device (3001) according to claim 2, wherein for performing the combining of the obtained outputs (321, 341), the first device (3001) is configured to concatenate activation vectors of the output layers of the NNs (320, 340) comprised in the at least two second devices (3002, 3004).

4. The first device (3001) according to claim 2, further configured to:
perform backpropagation to obtain an error vector of the input layer of the NN (310) comprised in the first device (3001);
split the obtained error vector based on the sizes of the output layers of the NNs (320, 340) comprised in the at least two second devices (3002, 3004) accordingly to obtain a set of split error vectors (311, 312); and
provide the set of split error vectors (311, 312) to the output layers of the NNs (320, 340) comprised in the at least two second devices (3002, 3004) accordingly, so that the NNs (320, 340) comprised in the at least two second devices (3002, 3004) are configured to perform backpropagation based on the respective split error vectors (311, 312) accordingly.

5. The first device (4001) according to claim 1, wherein a size of an input layer of the NN (410) comprised in the first device (4001) is equal to a size of each output layer of the NNs (420, 440) comprised in the at least two second devices (4002, 4004).

6. The first device (4001) according to claim 5, wherein for performing the combining of the obtained outputs, the first device (4001) is configured to perform element-wise summation of activation vectors of the output layers of the NNs (420, 440) comprised in the at least two second devices (4002, 4004).

7. The first device (4001) according to claim 5, further configured to
perform backpropagation to obtain an error vector of the input layer of the NN (410) comprised in the first device (4001); and
broadcast the obtained error vector to each of the at least two devices, so that the NNs (420, 440) comprised in the at least two second devices (4002, 4004) are configured to perform backpropagation based on the broadcast error vector.

8. The first device (4001) according to claim 1, wherein the first device (4001) is a base station or a unit attachable to a base station.

9. A communication network comprising at least two second devices (3002, 3004; 4002, 4004), wherein each second device (3002, 3004; 4002, 4004) comprises a neural network, NN (320, 340; 420, 440), and wherein the at least two second devices (3002, 3004; 4002, 4004) are configured to:
respectively obtain an input for the respective NN (320, 340; 420, 440);
concurrently run the respective NN (320, 340; 420, 440) based on the respective input to obtain outputs (321, 341; 421, 441) ; and
respectively provide each output (321, 341; 421, 441) to a first device (3001; 4001).

10. The communication network according to claim 9, wherein the inputs of the at least two second devices (3002, 3004; 4002, 4004) are distinct.

11. The communication network according to claim 10, wherein each input of the at least two second devices (3002, 3004; 4002, 4004) is a subset of a complete data obtained from a common data source or from different data sources.

12. The communication network according to claim 9, wherein the at least two second devices (3002, 3004; 4002, 4004) are further configured to:
respectively receive an error vector (311, 312; 411, 411) from the first device (3001; 4001); and
respectively perform backpropagation based on the received error vector (311, 312; 411, 411).

13. The communication network according to claim 9, wherein one or more parameters of the NNs (320, 340; 420, 440) comprised in the at least two second devices (3002, 3004; 4002, 4004) are different, wherein the one or more parameters comprise at least one of the following:
the number of layers;
the number of neurons in each layer;
weights; and
biases.

14. The communication network according to claim 9, wherein each of the at least two second devices (3002, 3004; 4002, 4004) is a base station or a unit attachable to a base station.

15. A communication system comprising at least one first device (3001; 4001) and a communication network, wherein the communication network comprises at least two second devices (3002, 3004; 4002, 4004), each of the first device (3001; 4001) and the at least two second devices (3002, 3004; 4002, 4004) comprises a neural network, NN (310; 410; 320, 340; 420, 440), and
the first device (3001; 4001) is configured to:
obtain outputs (321, 341; 421, 441) of the NNs (320, 340; 420, 440) comprised in the at least two second devices (3002, 3004; 4002, 4004);
combine the obtained outputs (321, 341; 421, 441) to generate a combined output;
provide the combined output as an input to the NN (310; 410) comprised in the first device (3001; 4001); and
run the NN (310; 410) comprised in the first device (3001; 4001) based on the input;
the at least two second devices (3002, 3004; 4002, 4004) are configured to:
respectively obtain an input for the respective NN (320, 340; 420, 440);
concurrently run the respective NN (320, 340; 420, 440) based on the respective input to obtain outputs (321, 341; 421, 441) ; and
respectively provide each output (321, 341; 421, 441) to a first device (3001; 4001).

16. A method (800) performed by a first device (3001; 4001) for a communication network, wherein the communication network comprises at least two second devices (3002, 3004; 4002, 4004), wherein each of the first device (3001; 4001) and the at least two second devices (3002, 3004; 4002, 4004) comprises a neural network, NN, and wherein the method comprises:
obtaining (801) outputs of the NNs (320, 340; 420, 440) comprised in the at least two second devices (3002, 3004; 4002, 4004);
combining (802) the obtained outputs to generate a combined output;
providing (803) the combined output as an input to the NN (310; 410) comprised in the first device (3001; 4001); and
running (804) the NN (310; 410) comprised in the first device (3001; 4001) based on the input.

17. A method (900) for a communication network comprising at least two second devices (3002, 3004; 4002, 4004), wherein each second device comprises a neural network, NN (310; 410; 320, 340; 420, 440), and wherein the method comprises:
respectively obtaining (901), by the at least two second devices (3002, 3004; 4002, 4004), an input for the respective NN (320, 340; 420, 440);
concurrently running (902), by the at least two second devices (3002, 3004; 4002, 4004), the respective NN (320, 340; 420, 440) based on the respective input to obtain outputs; and
respectively providing (903), by the at least two second devices (3002, 3004; 4002, 4004), each output to a first device (3001; 4001).

18. A method (1000) for training neural networks, NNs comprised in a first device (3001; 4001) and at least two second devices (3002, 3004; 4002, 4004), the method comprising:
respectively obtaining (1001), by the at least two second devices (3002, 3004; 4002, 4004), an input for the respective NN (320, 340; 420; 440);
concurrently running (1002), by the at least two second devices (3002, 3004; 4002, 4004), the respective NN (320, 340; 420; 440) based on the respective input to obtain outputs;
respectively providing (1003), by the at least two second devices (3002, 3004; 4002, 4004), each output to the first device (3001; 4001);
obtaining (1004), by the first device (3001; 4001), the outputs of the NNs (320, 340; 420; 440) comprised in the at least two second devices (3002, 3004; 4002, 4004);
combining (1005), by the first device (3001; 4001), the obtained outputs to generate a combined output;
providing (1006), by the first device (3001; 4001), the combined output as an input to the NN (310; 410) comprised in the first device (3001; 4001);
running (1007), by the first device (3001; 4001), the NN (310; 410) comprised in the first device (3001; 4001) based on the input;
obtaining (1008), by the first device (3001; 4001), an output of the NN (310; 410) comprised in the first device (3001; 4001);
performing (1009), by the first device (3001; 4001), backpropagation to optimize parameters of the NN (310; 410) comprised in the first device (3001; 4001) based on the obtained output of the NN (310; 410) comprised in the first device (3001; 4001), and to obtain an error vector of an input layer of the NN (310; 410) comprised in the first device (3001; 4001);
providing (1010), by the first device (3001; 4001), the error vector to the at least two devices (3002, 3004; 4002, 4004);
respectively receiving (1011), by the at least two second devices (3002, 3004; 4002, 4004), a respective error vector from the first device (3001; 4001); and
respectively performing (1012), by the at least two second devices (3002, 3004; 4002, 4004), backpropagation based on the received error vector to optimize parameters of the respective NN (320, 340; 420; 440).

19. A computer program product comprising a program code for performing the method according to claim 16, when executed on a computer.

20. A computer program product comprising a program code for performing the method according to claim 17, when executed on a computer.

21. A computer program product comprising a program code for performing the method according to claim 18, when executed on a computer.
